(19) United States
(12) Patent Application Publication
(10) Pub. No.: US 2026/0107226 A1
(43) Pub. Date: Apr. 16, 2026

(54) METHOD AND APPARATUS FOR TARGET WAKE TIME-BASED POWER SAVING

(71) Applicant: Samsung Electronics Co., Ltd., Gyeonggi-do (KR)

(72) Inventors: Yongsen MA, Milpitas, CA (US); Michail KOUNDOURAKIS, Hamburg (DE); Mark Gorthorn RISON, Cambridge (GB); Srinivas KANDALA, Morgan Hill, CA (US); Ravi GIDVANI, Fremont, CA (US)

(21) Appl. No.: 19/354,365

(22) Filed: Oct. 9, 2025

Related U.S. Application Data
(60) Provisional application No. 63/706,207, filed on Oct. 11, 2024.

(51) Int. Cl. H04W 52/02

(52) U.S. Cl. CPC H04W 52/0229

(57) ABSTRACT

A system and a method are disclosed for power saving in a wireless device. A method includes entering into a power save mode including a first mode interval and a second mode interval, wherein the first mode interval corresponds to a high capability mode and the second mode interval corresponds to a reduced power mode; determining whether to operate in a low capability mode or a doze mode in the reduced power mode during the second mode interval; sending, to a second wireless device, an operation schedule based on the power save mode and the determination as to whether to operate in the low capability mode or the doze mode during the second mode interval; and transitioning between the high capability mode and the reduced power mode based on the operation schedule.

### CROSS-REFERENCE TO RELATED APPLICATION

This application claims the priority benefit under 35 U.S.C. § 119(e) of U.S. Provisional Application No. 63/706,207, filed on Oct. 11, 2024, the disclosure of which is incorporated by reference in its entirety as if fully set forth herein.

### TECHNICAL FIELD

The disclosure generally relates to power saving protocols for devices in a wireless communication system. More particularly, the subject matter disclosed herein relates to improving energy efficiency of an access point (AP) through balancing power saving and performance requirements using AP schedule and/or capability adjustments.

### SUMMARY

The number of wireless local area network (WLAN) devices has been steadily growing in recent years because of the increasing demand of wireless data and applications and the high performance and easy deployment of WLAN protocols.

Requirements and recommendations are currently being proposed from standard development organizations, e.g., Institute of Electrical and Electronics Engineers (IEEE), to improve energy efficiency of APs for sustainability purposes, such as meeting net zero and carbon neutral goals.

Existing power saving protocols have been designed mostly for non-AP stations (STAs), but do not focus on APs.

To solve this problem, in the next generation WLAN, i.e., Ultra High Reliability (UHR), an AP may enter a periodic power save mode or a doze state (or mode) outside of target wake time (TWT) service periods (SPs). For example, in IEEE Wi-Fi standards, a TWT SP is a negotiated time window during which Wi-Fi devices (e.g., STAs) and an AP agree to exchange data. This scheduled period allows STAs to wake up, send or receive data, and then return to a low-power doze state, thereby reducing energy consumption and contention in the network. More specifically, an AP in UHR can use a periodic unavailability operation (PUO) mode to conserve power. This mechanism allows the AP to periodically enter a power-saving state, i.e., an “unavailability” period, during periods of low activity. For example, the AP may create a schedule that includes time intervals for different power states, and then broadcast this schedule to STAs through frames, such as beacons or probe responses. The schedule may include intervals during which the AP enters a power-saving or doze state, i.e., an “unavailability” period, where the AP reduces its energy consumption. The schedule may also include SPs, which are intervals when the AP is fully awake and performs data exchanges.

One issue with the above approach is that an AP in a doze (or sleep) state outside of TWT SPs, i.e., in an “unavailability” period, is not able to receive or respond outside of the TWT SPs.

Another issue with the above approach is that pre-UHR STAs assume an AP is always available and may try to transmit to the AP outside of TWT SPs. The same may apply for STAs that are not aware of the current status of the AP, e.g., do not know that the AP is in doze state.

Another issue with the above approach is that UHR includes a dynamic power save (DPS) operation where an STA transitions from a lower capability mode to a higher capability mode after receiving an initial control frame (ICF). While DPS may allow for power conservation in UHR STAs by operating in a less capable mode for routine tasks and then activating advanced features like higher bandwidth and more spatial streams when an ICF triggers a mode switch for full performance, pre-UHR STAs do not operate in accordance with the DPS signaling/procedure. Accordingly, when pre-UHR STAs are present, an AP may enable DPS, and the pre-UHR STAs will operate in low capability, with reduced performance, or the AP may disable DPS, which then reduces the power save benefit, or frequent enablement/disablement actions with increased complexity may occur as pre-UHR STAs come and go.

Another issue with the above approach is that a UHR STA transitioning from a low-capability mode to a high-capability mode may increase overhead due to the use of ICFs, initial control responses (ICRs), intermediate frame check sequences (I-FCS), and padding. That is, while these mechanisms may facilitate a switch between modes, they also introduce overhead that may increase with the frequency of transitions.

To overcome these types of issues, systems and methods are described herein to extend a periodic AP power save mode and to improve energy efficiency of APs by adjusting capability modes based on TWT SPs. For example, instead of entering an “unavailability” period outside of a TWT SP, an AP may enter into a low capability mode in which it maintains the ability to receive or respond outside of the TWT SPs.

In an embodiment, a method comprises entering into a power save mode including a first mode interval and a second mode interval, wherein the first mode interval corresponds to a high capability mode and the second mode interval corresponds to a reduced power mode; determining whether to operate in a low capability mode or a doze mode in the reduced power mode during the second mode interval; sending, to a second wireless device, an operation schedule based on the power save mode and the determination as to whether to operate in the low capability mode or the doze mode during the second mode interval; and transitioning between the high capability mode and the reduced power mode based on the operation schedule.

In an embodiment, a wireless device comprises a transceiver; and a processor configured to enter the first wireless device into a power save mode including a first mode interval and a second mode interval, wherein the first mode interval corresponds to a high capability mode and the second mode interval corresponds to a reduced power mode, determine whether to operate in a low capability mode or a doze mode in the reduced power mode during the second mode interval, sending, via the transceiver, to a second wireless device, an operation schedule based on the power save mode and the determination as to whether to operate in the low capability mode or the doze mode during the second mode interval, and transition the first wireless device between the high capability mode and the reduced power mode based on the operation schedule.

### BRIEF DESCRIPTION OF THE DRAWING

In the following section, the aspects of the subject matter disclosed herein will be described with reference to exemplary embodiments illustrated in the figures, in which:

FIG. 1 illustrates an example of a PUO mode;

FIG. 2 illustrates an example of a power save mode including a low capability mode, according to an embodiment;

FIG. 3 illustrates an example of a power save mode including a low capability mode utilizing DPS, according to an embodiment;

FIG. 4A illustrates an example of a power save mode including a low capability mode, according to an embodiment;

FIG. 4B illustrates an example of a power save mode including a low capability mode, according to an embodiment;

FIG. 5 illustrates an example using a broadcast TWT recommendation field to indicate that a TWT is associated with a capability mode, according to an embodiment;

FIG. 6 illustrates an example using a control field or a broadcast (B)-TWT information field to indicate that a TWT is associated with a capability mode, according to an embodiment;

FIG. 7 is a flowchart illustrates a method performed by a device, according to an embodiment;

FIG. 8 is a block diagram of an electronic device in a network environment, according to an embodiment; and

FIG. 9 shows a system including a UE and a gNB in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An “access point” or “AP” as used herein refers to a hardware device that acts as a bridge, providing wireless connectivity for devices to connect to a wired network or the internet. For example, an AP may take a wired connection from a network and convert it into a wireless signal (e.g., Wi-Fi), allowing multiple wireless devices or STAs.

A “station” or “STA” as used herein refers to a device that can connect to a network, such as a laptop, smartphone, or even another AP.

A “non-AP STA” as used herein refers to a device, like a smartphone or laptop, that operates as a client on a network, but does not function as an AP itself.

A “target wake time” or “TWT” as used herein refers to a feature that allows STAs and APs to schedule specific “wake times”, i.e., SPs, for data transmission and reception, reducing power consumption by letting devices sleep for longer periods between active sessions.

Herein, “TWT SP” may be used as a general term that is not specific to a type of device, while “broadcast TWT SP” may be specific for an AP, and a “peer-to-peer (P2P) TWT SP” may be specific for a non-AP STA. For example, a broadcast TWT SP may be announced and managed by an AP in order to control schedules, and for a P2P TWT SP, a client device (i.e., a non-AP STA) may choose its own wake/sleep schedule and negotiate it with the AP.

“Dynamic power save” or “DPS” as used herein refers to adaptive power management schemes that allow devices (e.g., STAs) to dynamically adjust their power consumption based on network conditions and user activity, moving beyond fixed-schedule modes.

An “initial control frame” or ICF” as used herein refers to a control frame sent or received by a DPS-capable AP to or from a DPS non-AP STA to trigger a transition from a low-power mode to a high-power mode for more capable frame exchanges, such as for sounding procedures or high-performance data transmission. The ICF may provide signaling for the STA to adapt its capabilities, such as bandwidth and number of spatial streams (NSS), to meet the demands of the data exchange.

An “initial control response” or “ICR” as used herein refers to a control frame sent by a receiving device, e.g., STA, in response to an ICF, acknowledging the ICF and potentially providing additional information. The ICR may confirm that the devices are now operating in a high-power mode.

In order to address the various issues that may present by an AP using a PUO mode to conserve power, wherein the AP enters a power-saving doze state outside of TWT SPs, i.e., an “unavailability” period, during which it is not able to receive signals from or respond to an STA, the present disclosure provides various mechanisms to extend a periodic AP power save mode and improve energy efficiency of APs by adjusting capability modes based on TWT SPs.

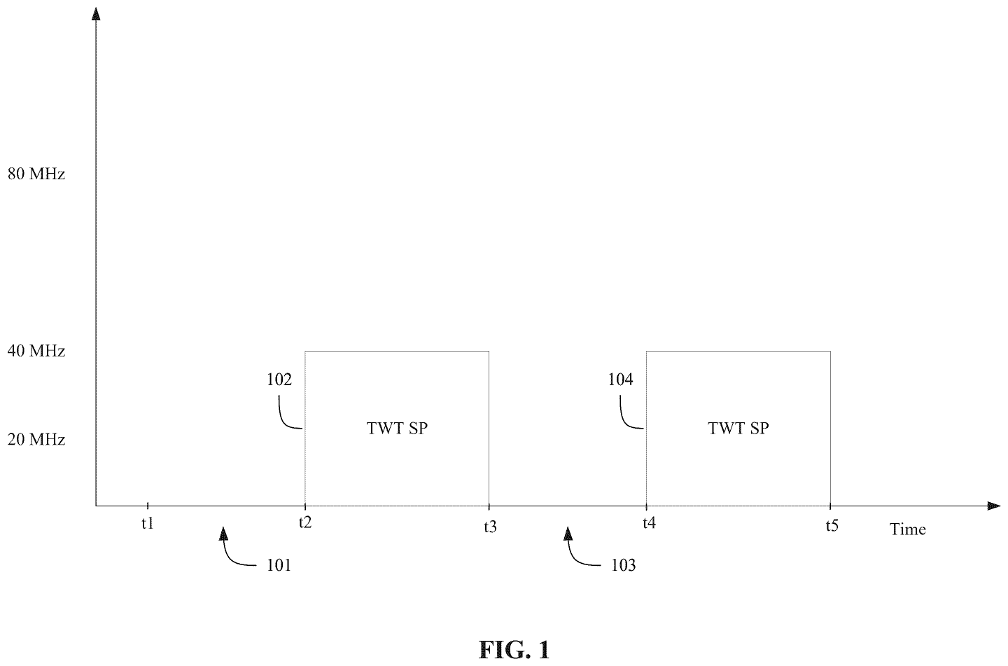

FIG. 1 illustrates an example of a PUO mode.

Referring to FIG. 1, an AP may use a PUO mode, which may include TWT SPs 102 and 104, e.g., a 40 MHz channel bandwidth, and doze (or sleep) states 101 and 103 at 0 MHz, to conserve power. More specifically, the AP may periodically enter a doze (or sleep) state 101 or 103 during periods of low activity. For example, the AP may create a schedule that includes time intervals for different power states, and then broadcast this schedule to STAs through frames, such as beacons or probe responses. The schedule may include intervals during which the AP enters the doze (or sleep) states, i.e., “unavailability” periods, at intervals 101 (from t1 to t2) and 103 (from t3 to t4), during which the AP reduces its energy consumption. The schedule may also include the TWT SPs 102 (from t2 to t3) and 104 (from t4 to t5), which are intervals during which the AP is fully awake and may perform data exchanges with one or more STAs.

However, as described above, when the AP is in the doze (or sleep) state 101 or 103, outside of the TWT SPs 102 and 104, it is not able to receive signals from or respond to an STA, which may cause various issues.

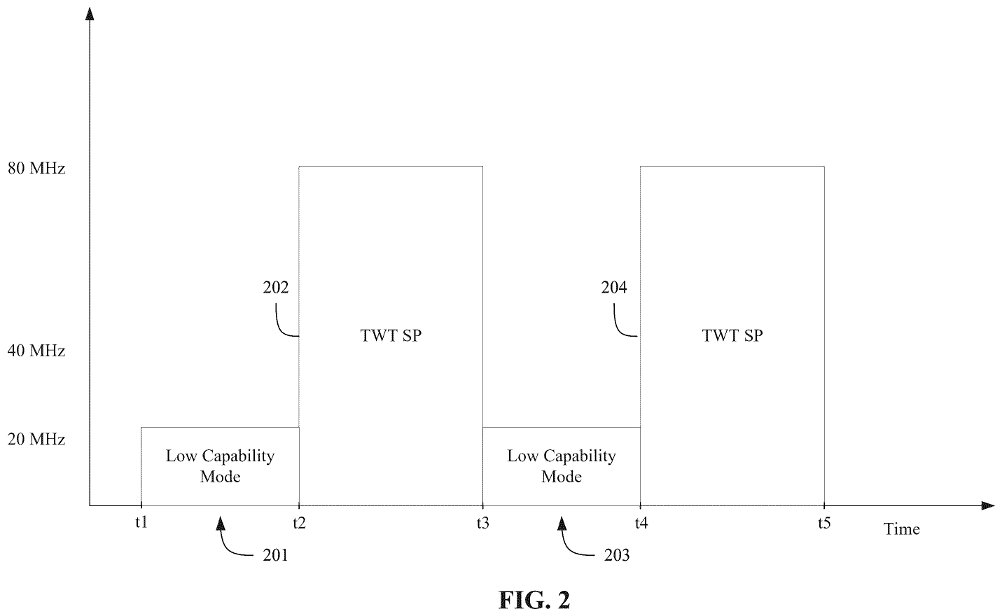

FIG. 2 illustrates an example of a power save mode including a low capability mode, according to an embodiment.

Referring to FIG. 2, rather than have “unavailability” periods outside of TWT SPs, e.g., as illustrated in FIG. 1, an AP may enter into a low capability mode with reduced power consumption while maintaining the ability to receive and respond to certain frames and/or requests. That is, instead of entering a doze or sleep state, the AP may enter into the low capability mode, wherein the AP is still available for certain operations, but operates at a reduced energy level compared to during a TWT SP.

More specifically, the AP may use a power save mode, which may include a high capability mode in TWT SPs 202 (interval t2 to t3) and 204 (interval t4 to t5), e.g., at 80 MHz channel bandwidth, and a low capability mode 201 (interval t1 to t2) and 203 (interval t3 to t4), e.g., at 20 MHz channel bandwidth, to conserve power. That is, a lower transmission bandwidth (e.g., 20 MHz) generally correlates with lower power consumption because less data is processed and transmitted over a shorter period, reducing the active time of the AP's components. While the higher bandwidth (e.g., 80 MHz) allows for rapid data transfer, this often requires higher power output.

The AP may periodically enter the low capability mode 201 or 203, rather than a sleep state, during periods of low activity, and maintain the ability to receive and respond to an upper layer or STAs. For example, while in the low capability mode at 201 or 203, the AP may switch to a high capability mode, upon receiving requests from an upper layer or from an STA. During the high capability mode, the AP may fully transmit and receive signals and/or data with STAs, e.g., perform regular AP operations.

The AP may create a schedule that includes time intervals for different power states, and then broadcast this schedule to STAs through frames, such as beacons or probe responses. The schedule may include the intervals during which the AP enters the low capability modes, i.e., at 201 (from t1 to t2) and 203 (from t3 to t4), during which the AP reduces its energy consumption, but still remains active. The schedule may also include TWT SPs 202 (from t2 to t3) and 204 (from t4 to t5), which are intervals during which the AP is fully awake and may operate in the high capability mode. For example, durations of the TWT SPs 202 (from t2 to t3) and 204 (from t4 to t5) may be 5120 μs, 10240 μs, 20480 μs, 40960 μs, or 81920 μs, but may vary accordingly based on network requirements.

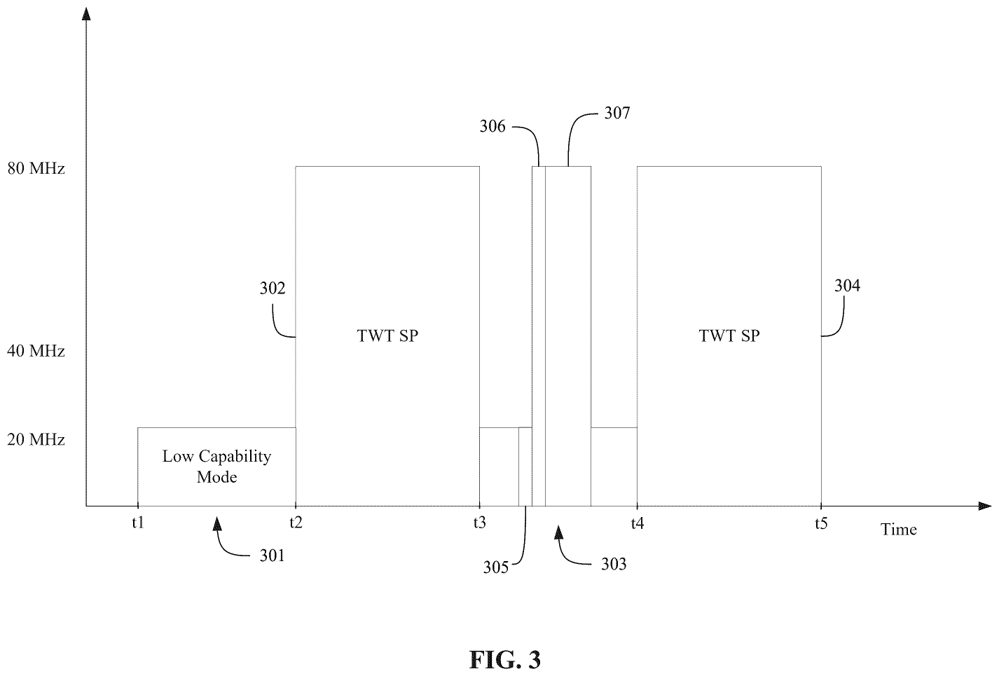

FIG. 3 illustrates an example of a power save mode including a low capability mode utilizing DPS, according to an embodiment. More specifically, in FIG. 3, during low capability mode 301 and 303, DPS may be enabled, and during TWT SPs 302 and 304, i.e., high capability mode intervals, DPS may be disabled. For example, the low capability mode 301 and 303 and the TWT SPs 302 and 304 may be the same as or similar to the low capability mode 201 and 203 and the TWT SPs 202 and 204, respectively, in FIG. 2.

Referring to FIG. 3, similar to FIG. 2, rather than have “unavailability” periods outside of TWT SPs, e.g., as illustrated in FIG. 1, an AP may enter into a low capability mode with reduced power consumption while maintaining the ability to receive and respond to certain frames and/or requests.

More specifically, the AP may use a power save mode, which may include the high capability mode in TWT SPs 302 (interval t2 to t3) and 304 (interval t4 to t5), e.g., at 80 MHz channel bandwidth, and low capability mode intervals 301 (interval t1 to t2) and 303 (interval t3 to t4), e.g., at 20 MHz channel bandwidth, to conserve power. Like the operations in FIG. 2, the AP may periodically enter the low capability mode 301 or 303, rather than a sleep state, during periods of low activity, and maintain the ability to receive and respond to an upper layer or STAs. For example, while in the low capability mode at 301 or 303, the AP may switch to a high capability mode, upon receiving requests from an upper layer or from an STA.

The AP may create a schedule that includes time intervals for different power states, and then broadcast this schedule to STAs through frames, such as beacons or probe responses. The schedule may include the intervals during which the AP enters the low capability modes, i.e., at 301 (from t1 to t2) and 303 (from t3 to t4), during which the AP reduces its energy consumption, but still remains active. The schedule may also include TWT SPs 302 (from t2 to t3) and 304 (from t4 to t5), which are intervals during which the AP is fully awake and operating in the high capability mode.

Different from the operation in FIG. 2, FIG. 3 illustrates the utilization of DPS, e.g., during the low capability mode interval 303.

More specifically, while operating in the low capability mode 303, wherein the AP reduces its energy consumption, but still remains active, the AP may transmit or receive, to or from an STA, an ICF 305 to trigger a transition from a low-power mode to a high-power mode, i.e., from the low capability mode 303 to a high-power mode, for more capable frame exchanges.

Thereafter, the AP may switch to a high-power mode, e.g., the high capability mode, and receive or transmit an ICR 306 from or to the STA, and at interval 307, the AP and the STA may transmit and receive data.

Upon completion of the data exchange, at interval 307, the AP may switch back to the low capability mode 303 until t4.

Accordingly, the AP can reuse the high and low capability modes used for unscheduled/DPS, and can coexist with unscheduled/DPS, both inside and outside of TWT SPs 302 and 304.

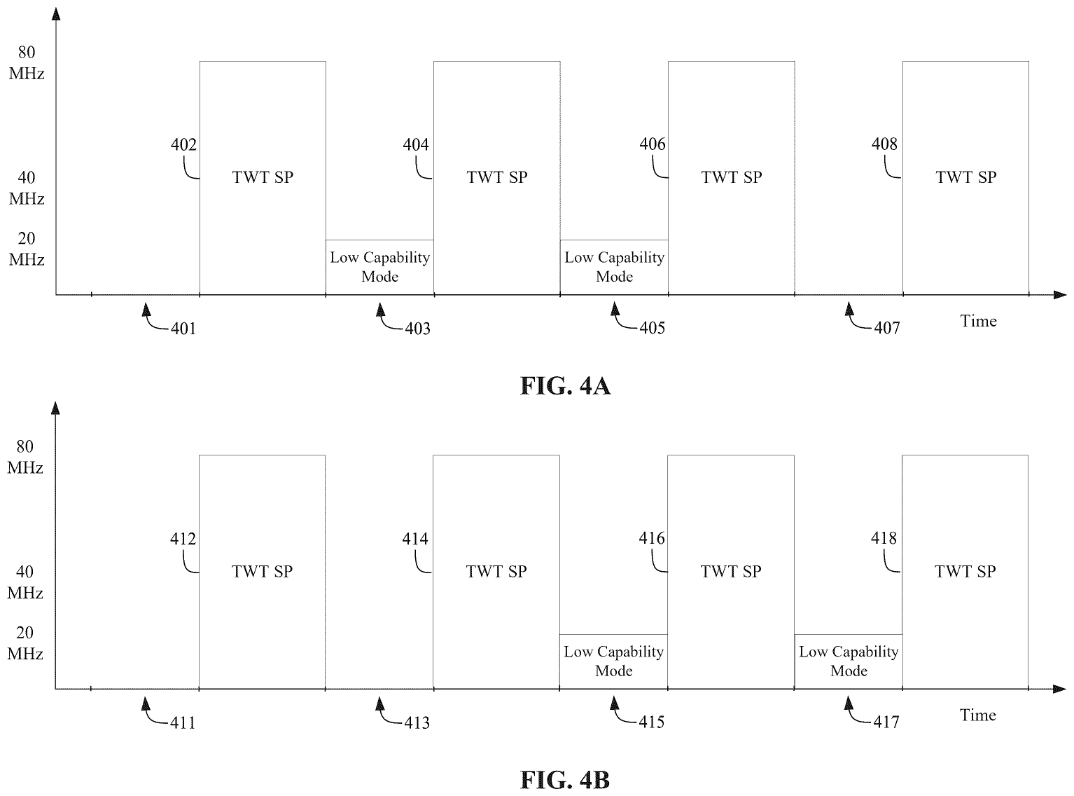

FIG. 4A illustrates an example of a power save mode including a low capability mode, according to an embodiment.

Referring to FIG. 4A, outside of TWT SPs, an AP may enter into a doze (or sleep) state (e.g., similar to FIG. 1) or into a low capability mode with reduced power consumption while maintaining the ability to receive and respond to certain frames and/or requests (e.g., similar to FIG. 2).

More specifically, the AP may use a power save mode including first and second mode intervals. The first mode intervals, e.g., active or high capability modes, may include TWT SPs 402, 404, 406, and 408, and the second mode intervals, e.g., reduced power modes, may include a low capability mode at 403 and 405, and a doze (or sleep) mode at 401 and 407, outside of the TWT SPs 402, 404, 406, and 408.

Although FIG. 4A illustrates an example in which the AP enters into a low capability mode in the second and third second mode intervals and enters into a doze (or sleep) mode in the first and fourth second mode intervals outside of the TWT SPs 402, 404, 406, and 408, the present disclosure is not limited thereto (e.g., see FIG. 4B). That is, the AP may enter either a low capability mode or a doze (or sleep) mode based on different factors, such as traffic/channel load, performance requirement, power save requirement, etc. For example, in a scenario with a higher performance requirement than power save requirement, the AP may enter into a low capability mode more often than a doze (or sleep) mode. As another example, in a scenario with a higher power save requirement than performance requirement, the AP may enter into a doze (or sleep) mode more often than a low capability mode.

Similar to FIGS. 2 and 3, the AP may create a schedule that includes time intervals for different power states, and then broadcast this schedule to STAs through frames, such as beacons or probe responses. The schedule may include the intervals during which the AP enters the low capability modes 403 and 405, during which the AP reduces its energy consumption, but still remains active, and the intervals during which the AP enters the doze (or sleep) mode 401 and 407, i.e., “unavailability” periods. The schedule may also include the TWT SPs 402, 404, 406, and 408, which are intervals during which the AP is fully awake and may operate in the high capability mode.

FIG. 4B illustrates an example of a power save mode including a low capability mode, according to an embodiment.

Referring to FIG. 4B, similar to FIG. 4A, outside of TWT SPs, an AP may enter into a doze (or sleep) state (e.g., similar to FIG. 1) or into a low capability mode with reduced power consumption while maintaining the ability to receive and respond to certain frames and/or requests (e.g., similar to FIG. 2).

More specifically, the AP may use a power save mode including first and second mode intervals. The first mode intervals, e.g., active or high capability modes, may include TWT SPs 412, 414, 416, and 418, and the second mode intervals, e.g., reduced power modes, may include a low capability mode at 415 and 417, and a doze (or sleep) mode at 411 and 413, outside of the TWT SPs 412, 414, 416, and 418.

As an alternative from FIG. 4A, FIG. 4B illustrates an example in which the AP enters the doze (or sleep) mode at 411 and 413 in the first and second second mode intervals, and then enters the low capability mode at 415 and 417 in the third and fourth second mode intervals. As described above, the AP may enter either a low capability mode or a doze (or sleep) mode based on different factors, such as traffic/channel load, performance requirement, power save requirement, etc.

Similar to FIGS. 2 and 3, the AP may create a schedule that includes time intervals for different power states, and then broadcast this schedule to STAs through frames, such as beacons or probe responses. The schedule may include the intervals during which the AP enters the low capability modes 415 and 417, during which the AP reduces its energy consumption, but still remains active, and the intervals during which the AP enters the doze (or sleep) mode 411 and 413, i.e., “unavailability” periods. The schedule may also include the TWT SPs 412, 414, 416, and 418, which are intervals during which the AP is fully awake and may operate in the high capability mode.

Although not illustrated in FIGS. 4A and 4B, during any of the low capability modes 403, 405, 415, or 417, the AP may utilize DPS, e.g., as illustrated in FIG. 3. That is, during any of the low capability modes 403, 405, 415, or 417, the AP may transmit or receive, to or from an STA, an ICF to trigger a transition from a low-power mode to a high-power mode for more capable frame exchanges. Thereafter, the AP may switch to a high capability mode and receive or transmit an ICR from or to the STA, and the AP and the STA may transmit and receive data. Upon completion of the data exchange, the AP may then switch back to the low capability mode 403, 405, 415, or 417.

According to an embodiment, an AP may adjust TWT SP, e.g., duration, interval, and/or persistence, to change how long and/or often the AP operates in low capability and high capability modes. These adjustments may be based on traffic/channel load, performance requirements, a number of capability switch requests (e.g., ICFs) received over a certain period, e.g., receiving ICFs exceeding a preset threshold over a certain time period, and/or power save requirements e.g., achieving a certain power saving or not operating above a certain power level. Additionally, the different mode intervals may be different lengths.

For example, for a low traffic/channel load, a low performance requirement, or a high power save requirement, the AP may set a relatively longer duration for a low capability mode and/or set a relatively shorter duration for a high capability mode. That is, the AP can extend the low capability mode duration and/or shorten the high capability mode duration. The AP may also be in a low capability by default. In this case, mode switch requests may be made in an ICF from an AP or STA to let the AP switch to a high capability mode when needed.

As another example, for a high traffic/channel load, a high performance requirement, a low power save requirement, or many/frequent capability switch requests, e.g., above a preset threshold over a time period, the AP may set a relatively longer duration for a high capability mode, and/or set a relatively shorter duration for a low capability mode. That is, the AP can shorten the low capability mode duration and/or extend the high capability mode duration. The AP may also be in a high capability mode by default, which may reduce overhead from mode switch requests, mode switch operations, and extra padding, e.g., in ICF signaling.

According to an embodiment, an AP may indicate that the AP operates in a low capability mode outside of TWT SPs and that a TWT SP is associated with certain capability modes. The indication may be in an existing frame/element (e.g., a broadcast TWT recommendation field, a control field, or a B-TWT information field) or in a new frame/element. For example, reserved values or fields of TWT signals may be utilized that the AP operates in a low capability mode outside of TWT SPs and that a TWT SP is associated with certain capability modes.

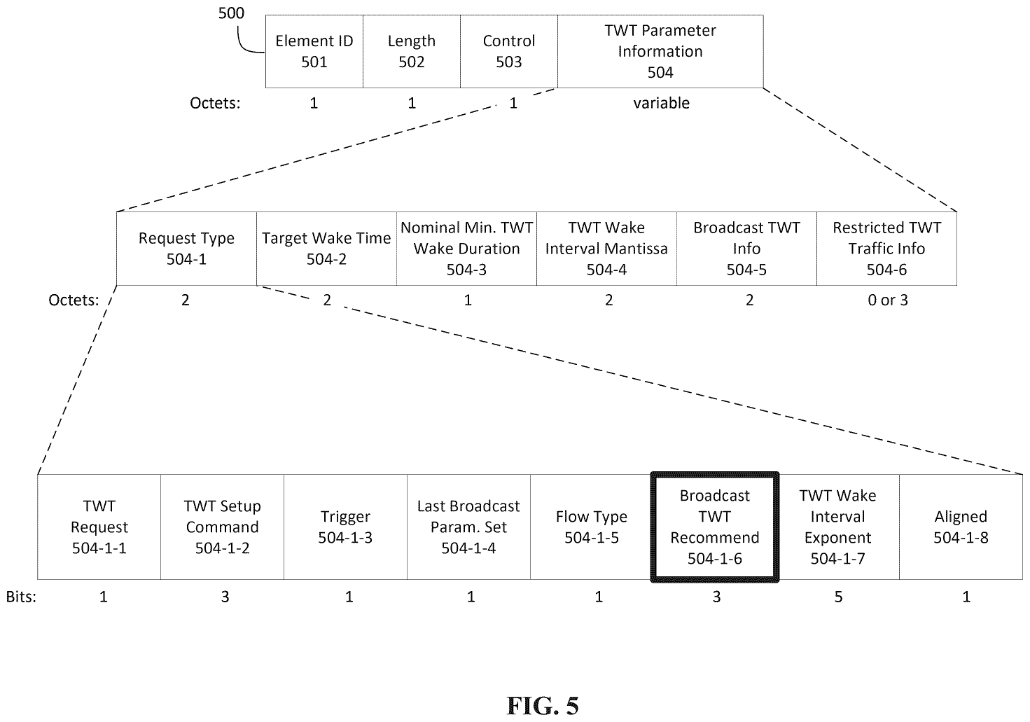

FIG. 5 illustrates an example using a broadcast TWT recommendation field to indicate that a TWT is associated with a capability mode, according to an embodiment. That is, FIG. 5 illustrates an example of using an existing frame of a TWT information element (IE), e.g., as in IEEE 802.11ax, to indicate a low capability mode outside of TWT SPs and that a TWT SP is associated with certain capability modes.

Referring to FIG. 5, a TWT element 500 may include an element identification (ID) field 501, a length field 502, a control field 503, and a TWT parameter information field 504. The element ID field 501 may be 1 octet, the length field 502 may be 1 octet, the control field 503 may be 1 octet, and the TWT parameter information field 504 may have a variable length. More specifically, the TWT element 500 is an IE included in 802.11 management frames that convey information to establish and manage TWT agreements. The element ID field 501 may identify the element's type in a management frame. The length field 502 may indicate a total number of octets in the control field 503 and the TWT parameter information filed 504. The control field 503 may define types of agreements, power save modes, and information relevant to the agreement setup. The TWT parameter information field 504 may include parameter sets for one or multiple TWT agreements.

The TWT parameter information field 504 may include a request type field 504-1, a target wake time field 504-2, a nominal minimum TWT wake duration field 504-3, a TWT wake interval mantissa field 504-4, a broadcast TWT information field 504-5, and a restricted TWT traffic information field 504-6. The request type field 504-1 may be 2 octets, the target wake time field 504-2 may be 2 octets, the nominal minimum TWT wake duration field 504-3 may be 1 octet, the TWT wake interval mantissa field 504-4 may be 2 octets, the broadcast TWT information field 504-5 may be 2 octets, and the restricted TWT traffic information field 504-6, which is an optional field, may be 0 to 3 octet.

The request type field 504-1 may include a TWT request field 504-1-1, a TWT setup command field 504-1-2, a trigger field 504-1-3, a last broadcast parament set field 504-1-4, a flow type field 504-1-5, a broadcast TWT recommendation field 504-1-6, a TWT wake interval exponent field 504-1-7, and an aligned field 504-1-8. The TWT request field 504-1-1 may be 1 bit, the TWT setup command field 504-1-2 may be 3 bits, the trigger field 504-1-3 may be 1 bit, the last broadcast parament set field 504-1-4 may be 1 bit, the flow type field 504-1-5 may be 1 bit, the broadcast TWT recommendation field 504-1-6 may be 3 bits, the TWT wake interval exponent field 504-1-7 may be 5 bits, and an aligned field 504-1-8 may be 1 bit.

Currently, the values 5-7 of the 3 bit broadcast TWT recommendation field 504-1-6 are reserved. Therefore, according to an embodiment of the disclosure, these reserved values may be utilized to indicate a low capability mode outside of TWT SPs and that a TWT SP is associated with certain capability modes.

For example, setting the value of the broadcast TWT recommendation field 504-1-6 to 5, may indicate low capability mode operation outside of TWT SPs, and setting the value of the broadcast TWT recommendation field 504-1-6 to 6, may indicate low capability mode with DPS enabled outside of the TWT SPs.

As another example, setting the value of the broadcast TWT recommendation field 504-1-6 to 5, may indicate that TWT SPs are for PUO, and that another existing field, e.g., a broadcast TWT ID field is being reused to indicate low capability mode (optionally with DPS enabled) outside of the TWT SPs.

As yet another example, setting the value of the broadcast TWT recommendation field 504-1-6 to 5, may indicate that TWT SPs are for PUO, and a new PUO operation parameters element/field may be used to indicate the low capability mode (optionally with DPS enabled) outside of the TWT SPs.

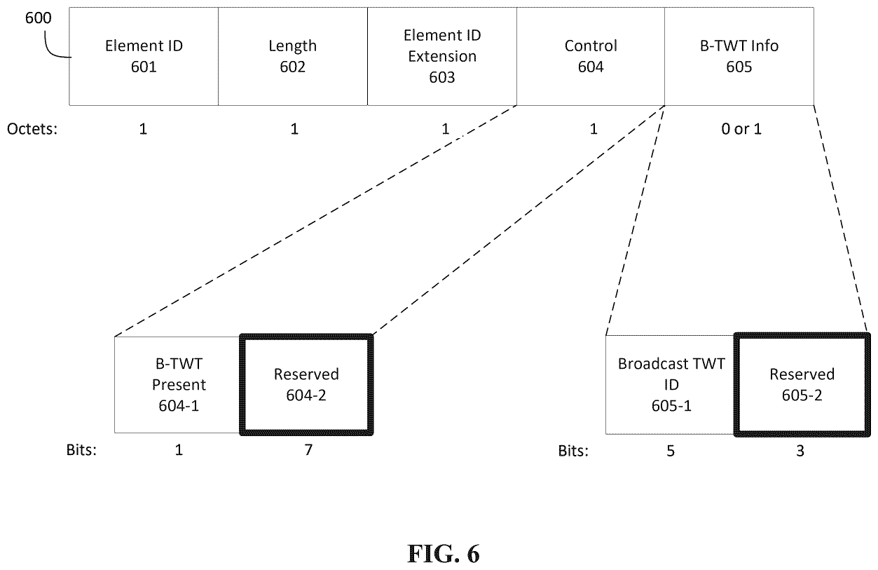

FIG. 6 illustrates an example using a control field or a B-TWT information field to indicate that a TWT is associated with a capability mode, according to an embodiment. That is, FIG. 6 illustrates examples of using an existing frame of a TWT IE, e.g., as in IEEE 802.11ax, to indicate a low capability mode outside of TWT SPs and that a TWT SP is associated with certain capability modes.

Referring to FIG. 6, a TWT information extension element 600 may include an element ID field 601, a length field 602, an element ID extension field 603, a control field 604, and a B-TWT information field 605. The element ID field 601 may be 1 octet, the length field 602 may be 1 octet, the element ID extension field 603 may be 1 octet, the control field 604 may be 1 octet, and the B-TWT information field 605, which is an optional field, may be 0 or 1 octet. As one example, i.e., using the control field 604 to indicate that a TWT is associated with a capability mode, e.g., when the B-TWT information field 605 is not included in the TWT information extension element format 600, the control field 604 may include a B-TWT information present field 604-1 and a reserved field 604-2. The B-TWT information present field 604-1 may be 1 bit and the reserved field 604-2 may be 7 bits. Therefore, according to an embodiment of the disclosure, these 7 reserved bits may be utilized to indicate a low capability mode outside of TWT SPs and that a TWT SP is associated with certain capability modes. For example, in the reserved field 604-2, a first bit set 1 may indicate a low capability mode outside of TWT SPs, and/or second bit set 1 may indicate a low capability mode with DPS enabled outside of the TWT SPs.

As another example, i.e., using the B-TWT information field 605 to indicate that a TWT is associated with a capability mode, the B-TWT information field 605 may include a broadcast TWT ID field 605-1 and a reserved field 605-2. The broadcast TWT ID field 605-1 may be 5 bits and the reserved field 605-2 may be 3 bits. Therefore, according to an embodiment of the disclosure, these 3 reserved bits may be utilized to indicate a low capability mode outside of TWT SPs and that a TWT SP is associated with certain capability modes. For example, in the reserved field 605-2, a first bit set to 1 may indicate a low capability mode outside of TWT SPs, and a second bit set to 1 may indicate a low capability mode with DPS enabled outside of the TWT SPs.

Compared with the example in FIG. 5, the examples of FIG. 6 reusing a TWT information extension element may provide more flexibility than reusing a TWT element, but may have higher overhead.

According to an embodiment, to indicate that an AP operates in a low capability mode outside of TWT SPs and that a TWT SP is associated with certain capability modes, a new frame and/or element may be utilized. For example, UHR capabilities elements may be implemented, which indicate a low/high capability mode and/or DPS enablement in similar manners as used in the TWT IEs as described above in FIGS. 5 and 6.

Other options may include an indication that a capabilities element is used together with a certain TWT.

Moreover, an AP may send an operating mode indication (OMI) and/or an operating mode notification (OMN) together with a certain TWT. For example, in IEEE, an OMI is a mechanism for an initiating device (e.g., an AP) to tell another responding device (e.g., an STA) about changes in its operating parameters, such as channel width or NSS. The initiator may send a frame containing an operating mode (OM) control subfield, and the responder may use this information to adjust its own transmission parameters when communicating back to the initiator. This may allow for dynamic adjustments to be made in a transmission environment, allowing for the AP to indicate that it operates in a low capability mode outside of TWT SPs and that a TWT SP is associated with certain capability modes.

Similarly, an OMN is a type of frame that may be used by a device (e.g., an AP or a STA) to inform other devices about its current operational capabilities, such as supported bandwidth (channel width) and NSS. This notification allows devices to ensure they can send and receive frames within compatible parameters, and may allow for the AP to indicate that it operates in a low capability mode outside of TWT SPs and that a TWT SP is associated with certain capability modes.

Additionally, an AP may indicate operation in a low capability mode outside of TWT SPs and that a TWT SP is associated with certain capability modes similar to high and low capability modes from DPS, e.g., which can be announced in beacons or ICFs.

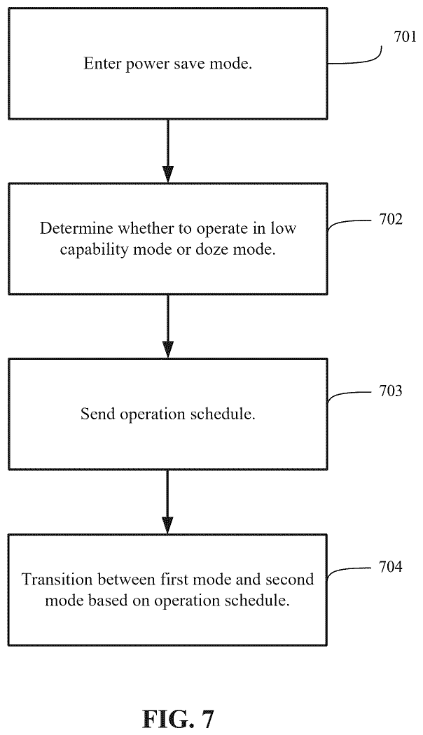

FIG. 7 is a flowchart illustrates a method performed by a device, according to an embodiment.

Referring to FIG. 7, the device, e.g., an AP, at step 701, enters into a power save mode including a first mode interval and a second mode interval. For example, the first mode interval may correspond to a TWT SP, e.g., an active or high capability mode, and the second mode interval may correspond to an interval outside of the TWT SP, e.g., a reduced power mode.

At step 702, the AP may determine whether to operate in a low capability mode or a doze mode during the second mode interval. As described above, e.g., in FIGS. 4A and 4B, during a low capability mode interval, the AP may reduce its energy consumption, but still remain active, and during a doze (or sleep) mode interval, the AP may enter an “unavailability” period.

At step 703, the AP may broadcast or transmit an operation schedule based on the power save mode and the determination as to whether to operate in the low capability mode or the doze mode during the second mode interval. For example, the AP may create an operation schedule that includes timings for the first mode interval and the second mode interval, i.e., the different power states, and an indication, e.g., as illustrated in FIG. 5 or 6, of whether the AP will operate in the low capability mode or the doze mode during the second mode interval, and then broadcast this schedule to STAs through frames, such as beacons or probe responses.

At step 704, the AP transitions between the first mode and the second mode, i.e., the high capability mode and the reduced power mode, based on the operation schedule. For example, the AP may transition between a doze (sleep) mode, a low capability mode, and/or a high capability mode as illustrated in FIGS. 2, 3, 4A, and 4B.

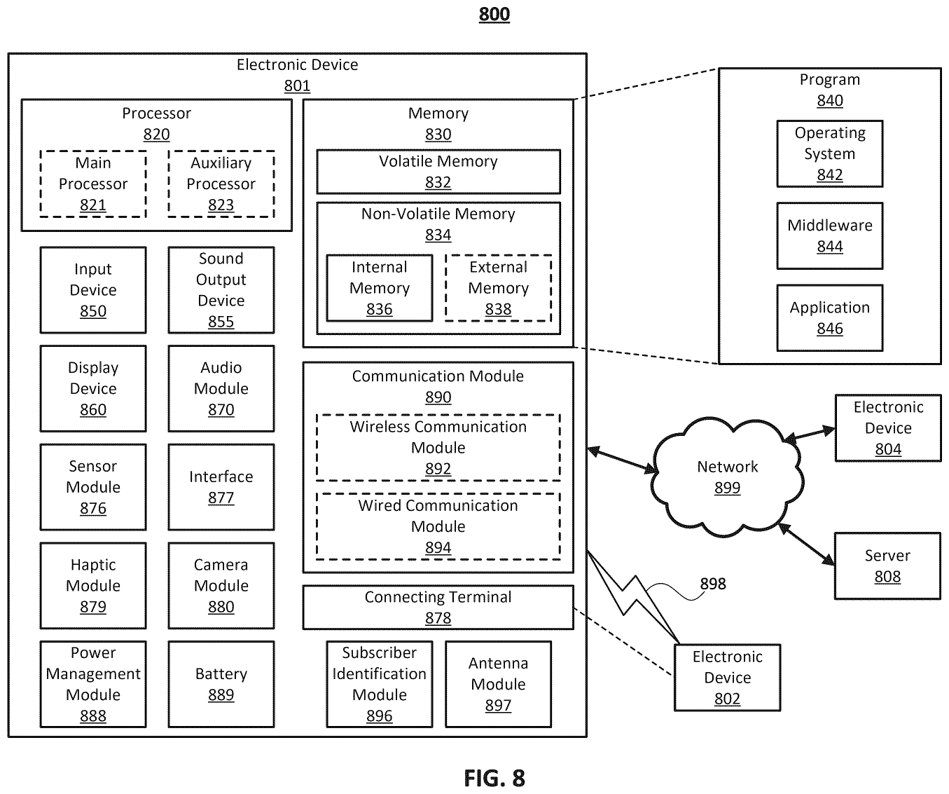

FIG. 8 is a block diagram of an electronic device in a network environment 800, according to an embodiment.

Referring to FIG. 8, an electronic device 801, e.g., an STA or an AP, in a network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations e.g., the methods illustrated in FIGS. 2, 3, 4A, 4B, and 7.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897, e.g., a transceiver, may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

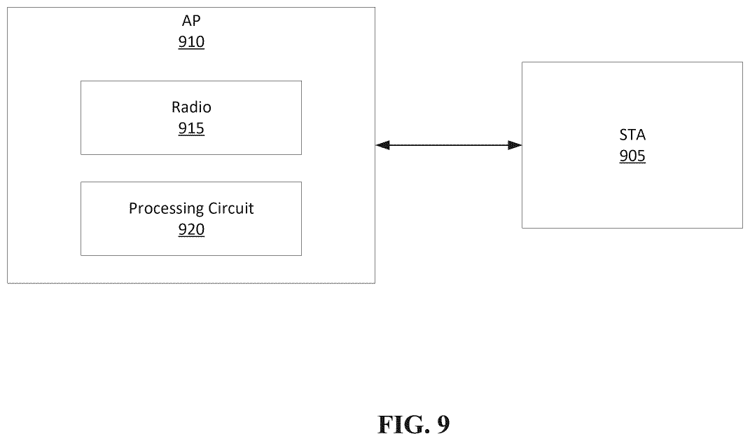

FIG. 9 illustrates a system including an STA 905 and an AP 910, in communication with each other, according to an embodiment. The AP 910 may include a radio 915 and a processing circuit (or a means for processing) 920, which may perform various methods disclosed herein, e.g., the method illustrated in FIGS. 2, 3, 4A, 4B, and 7. For example, the processing circuit 920 may receive, via the radio 915, transmissions from the STA 905, and the processing circuit 920 may transmit, via the radio 915, signals, e.g., a schedule that includes timings for a low capability mode interval and a high capability mode interval, i.e., the different power states of the AP 910, to the STA 905.

In accordance with the above-described embodiments, inside of a TWT SP, while an AP is in active state (e.g., high capability mode), both pre-UHR STAs and UHR STAs can operate in normal/high capability, without mode switch requests, mode switch operations, or extra padding. Additionally, outside of a TWT SP, the AP may be in a low capability mode, wherein the AP may operate with reduced power consumption, may receive and respond to certain frames/requests, and may switch to high capability mode, upon receiving requests from upper layer or other STAs.

While various embodiments of the disclosure are described above with reference to APs, the embodiments of the disclosure may also be applied to non-AP STAs. For example, instead of an AP broadcasting information to an STA regarding intervals for different power states, this type of information may be transmitted from a non-AP STA to an AP or from a non-AP STA to another non-AP STA using P2P signaling, e.g., P2P TWT SP.

Additionally, while various embodiments of the disclosure are described above with reference to devices, e.g., APs or STAs, operating in high capability modes inside of TWT SPs and in low capability modes outside of the TWT SPs, the embodiments of the disclosure may also be applied for a reverse scheme, wherein a device operates in a low capability mode or a doze state inside of TWT SPs and in a high capability mode outside of the TWT SPs.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a first wireless device, the method comprising:
entering into a power save mode including a first mode interval and a second mode interval, wherein the first mode interval corresponds to a high capability mode and the second mode interval corresponds to a reduced power mode;
determining whether to operate in a low capability mode or a doze mode in the reduced power mode during the second mode interval;
sending, to a second wireless device, an operation schedule based on the power save mode and the determination as to whether to operate in the low capability mode or the doze mode during the second mode interval; and
transitioning between the high capability mode and the reduced power mode based on the operation schedule.

2. The method of claim 1, wherein the first mode interval corresponds to a target wake time (TWT) service period (SP) and the second mode interval corresponds to an interval outside of the TWT SP.

3. The method of claim 2, wherein sending the operation schedule comprises transmitting the operation schedule in a TWT information element.

4. The method of claim 1, wherein sending the operation schedule comprises broadcasting the operation schedule to a plurality of wireless devices including the second wireless device.

5. The method of claim 1, wherein in the low capability mode, the first device operates at a reduced energy level compared to the high capability mode, and
wherein the reduced energy level is sufficient for the first wireless device to send or receive a signal to or from the second wireless device.

6. The method of claim 1, further comprising:
receiving, from the second wireless device, during the low capability mode, a signal indicating a transition from the low capability mode to a high-power mode; and
transitioning from the low capability mode to the high-power mode, based on the signal.

7. The method of claim 6, wherein the signal includes an initial control frame (ICF).

8. The method of claim 1, further comprising:
transmitting, to the second wireless device, during the low capability mode, a signal indicating a transition from the low capability mode to a high-power mode; and
transitioning from the low capability mode to the high-power mode, based on the signal.

9. The method of claim 8, wherein the signal includes an initial control frame (ICF).

10. The method of claim 1, further comprising adjusting at least one of a duration, an interval, or a persistence of at least one of the first mode interval or the second mode interval, based on at least one of a traffic load, a channel load, a performance requirement, a number of capability switch requests received over a time period, or a power save requirement.

11. A first wireless device, comprising:
a transceiver; and
a processor configured to:
enter the first wireless device into a power save mode including a first mode interval and a second mode interval, wherein the first mode interval corresponds to a high capability mode and the second mode interval corresponds to a reduced power mode,
determine whether to operate in a low capability mode or a doze mode in the reduced power mode during the second mode interval,
sending, via the transceiver, to a second wireless device, an operation schedule based on the power save mode and the determination as to whether to operate in the low capability mode or the doze mode during the second mode interval, and
transition the first wireless device between the high capability mode and the reduced power mode based on the operation schedule.

12. The first wireless device of claim 11, wherein the first mode interval corresponds to a target wake time (TWT) service period (SP) and the second mode interval corresponds to an interval outside of the TWT SP.

13. The first wireless device of claim 12, wherein the processor is further configured to send the operation schedule by transmitting the operation schedule in a TWT information element.

14. The first wireless device of claim 11, wherein the processor is further configured to send the operation schedule by broadcasting the operation schedule, via the transceiver, to a plurality of wireless devices including the second wireless device.

15. The first wireless device of claim 11, wherein the processor is further configured to, in the low capability mode, operate the first wireless device at a reduced energy level compared to the high capability mode, and
wherein the reduced energy level is sufficient for the first wireless device to send or receive a signal to or from the second wireless device.

16. The first wireless device of claim 11, wherein the processor is further configured to:
receive, from the second wireless device, via the transceiver, during the low capability mode, a signal indicating a transition from the low capability mode to a high-power mode, and
transition the first wireless device from the low capability mode to the high-power mode, based on the signal.

17. The first wireless device of claim 16, wherein the signal includes an initial control frame (ICF).

18. The first wireless device of claim 1, wherein the processor is further configured to:
transmit, to the second wireless device, via the transceiver, during the low capability mode, a signal indicating a transition from the low capability mode to a high-power mode, and
transition the first wireless device from the low capability mode to the high-power mode, based on the signal.

19. The first wireless device of claim 18, wherein the signal includes an initial control frame (ICF).

20. The first wireless device of claim 11, wherein the processor is further configured to adjust at least one of a duration, an interval, or a persistence of at least one of the first mode interval or the second mode interval, based on at least one of a traffic load, a channel load, a performance requirement, a number of capability switch requests received over a time period, or a power save requirement.
